(19) United States
(12) Patent Application Publication
(10) Pub. No.: US 2007/0041605 A1
(43) Pub. Date: Feb. 22, 2007

(54) EARPHONE AND SPEAKER MODULE FOR EARPHONE

(76) Inventor: Bill Yang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/162,855

(22) Filed: Sep. 26, 2005

(30) Foreign Application Priority Data
Aug. 17, 2005 (TW) 94127989

(51) Int. Cl. H04R 25/00

(52) U.S. Cl. 381/370; 381/374

(57) ABSTRACT

An earphone comprising an earphone housing and a speaker module is provided. The speaker module is disposed inside the earphone housing. The speaker module further comprises a speaker housing and a speaker unit. The speaker housing has a sound emission opening. In addition, the speaker housing constitutes a resonant chamber. The speaker unit is disposed inside the resonant chamber.

### CROSS-REFERENCE TO RELATED APPLICATION

This application claims the priority benefit of Taiwan application serial no. 94127989, filed on Aug. 17, 2005. All disclosure of the Taiwan application is incorporated herein by reference.

### BACKGROUND OF THE INVENTION

1. Field of the Invention

The present invention relates to an electronic product. More particularly, the present invention relates to an earphone and a speaker module for an earphone.

2. Description of the Related Art

With the continuous advance in technologies, lighter and smaller electronic products are produced. As electronic products gets smaller and lighter, more and more people are carrying these miniaturized products such as radio or portable music player around. In addition, the popularization of personal digital products such as MP3 players, mobile phones, personal digital assistants (PDA) and notebook computers has rendered such equipment an indispensable part of our daily life. Furthermore, mobile phones that combine the function of a radio and an MP3 are already out in the market.

Since the aforesaid electronic products are all portable and can be used in public places, the user of these products would prefer listening to music or voice messages in private without disturbing other people. Therefore, earphone has become an indispensable accessory for most electronic products. Moreover, the earphone can provide a better acoustic transmission to the listener so that the user is able to hear clearly and discern the content of voice messages unlike the cluttered transmission of sound in air. In particular, the listening is little affect by outside activities such as exercising, driving, performing violent activities or moving around a noisy environment.

FIG. 1 is a schematic cross-sectional view of a conventional earphone. As shown in FIG. 1, the conventional earphone 100 mainly comprises an earphone housing 110, a speaker unit 120 and a cap body 130. The cap body 130 has a plurality of first sound openings 132 for transmitting the sound produced by the speaker unit 120 to outside. In the conventional technique, the sound quality of the earphone 100 can be adjusted through the resonance effect produced by the resonance chamber S10 constructed through the assembly of the earphone housing 110 and the cap body 130. Additionally, the sound quality can also be adjusted by selectively forming a plurality of second sound openings 112 in the earphone housing 110. The practice of providing additional second sound openings 112 on the earphone housing also increases the variability of design of the earphone housing 110.

However, the aforementioned method of adjusting the sound quality of the earphone demands some trial-and-error and several design improvements before an earphone with optimal sound quality is produced. Furthermore, if a series of earphones with different housing styles is desired, the size and location of the sound openings has to be adjusted for each housing style. As a result, the cost of designing the earphone is increased. Moreover, the size and location of the openings also affects the aesthetic appeal of the earphone and hence must also be taken into consideration when optimizing the sound quality of the earphone. Thus, producing an aesthetically appealing earphone with superior sound quality at a minimum cost is an important issue for earphone manufacturers.

### SUMMARY OF THE INVENTION

Accordingly, at least one objective of the present invention is to provide an earphone speaker module having a lower design cost and a better aesthetic appearance.

At least a second objective of the present invention is to provide an earphone using the aforesaid speaker module to lower design cost and improve the aesthetic appeal of the earphone.

To achieve these and other advantages and in accordance with the purpose of the invention, as embodied and broadly described herein, the invention provides a speaker module for an earphone. The speaker module comprises a speaker housing and a speaker unit. The speaker housing forms a resonant chamber and has a sound output opening. The speaker unit is disposed inside the resonant chamber.

In one embodiment of the earphone speaker module, the earphone speaker module further comprises a cap body having a plurality of first sound openings that covers the sound output opening. In addition, the earphone speaker module may further include an ear pad disposed on the speaker housing.

Furthermore, the earphone speaker module may further include an electric wire and the speaker housing may further include an outlet wire opening, for example. The electric wire is electrically connected to the speaker unit and passes through the outlet wire opening to emerge from the speaker housing.

The present invention also provides an earphone. The earphone comprises an earphone housing and a speaker module. The speaker module is disposed inside the earphone housing. Furthermore, the speaker module comprises the aforesaid speaker housing and the speaker unit.

In one embodiment of the earphone, the speaker module further includes a cap body. The cap body has a plurality of first sound openings that covers the output sound opening. In addition, the earphone may further include an ear pad disposed on the earphone housing.

Furthermore, the speaker module may further include an electric wire. The speaker housing and the earphone housing individually have an outlet wire opening. The electric wire is electrically connected to the speaker unit and passes through the outlet wire openings to emerge from the earphone housing. In addition, the earphone may also include a plurality of decorative holes disposed on the earphone housing.

In the present invention, the earphone has an earphone housing and a speaker module. Furthermore, the speaker housing of the speaker module has a sound output opening. The speaker module has already had its sound quality adjustment completed. In other words, the sound quality of the speaker module has been properly adjusted to produce stable and unchanging sound so that the speaker module can be installed inside various types of earphone housing.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional earphone.

FIG. 2 is a schematic cross-sectional view of an earphone according to a first embodiment of the present invention.

FIG. 3 is a schematic cross-sectional view of an earphone according to a second embodiment of the present invention.

FIG. 4 is a schematic cross-sectional view of an earphone according to a third embodiment of the present invention.

FIG. 5 is a schematic cross-sectional view of an earphone according to a fourth embodiment of the present invention.

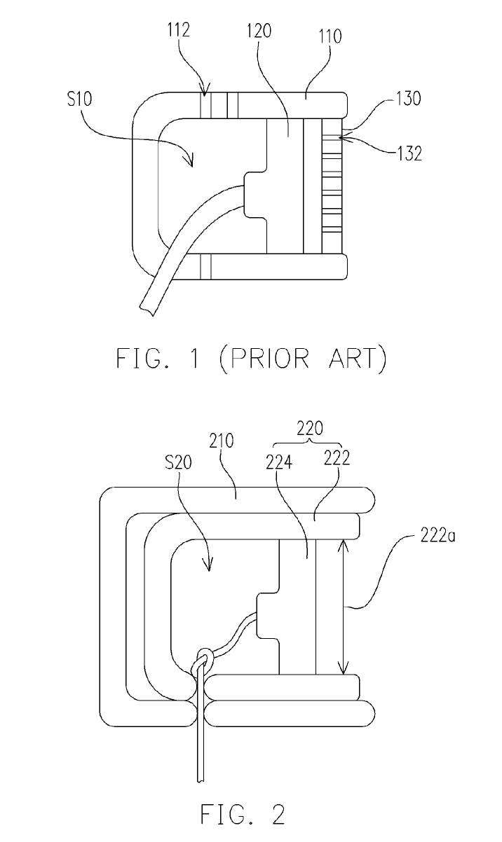

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

FIG. 2 is a schematic cross-sectional view of an earphone according to a first embodiment of the present invention. As shown in FIG. 2, the earphone in the present embodiment comprises an earphone housing 210 and a speaker module 220. The speaker module 220 is disposed inside the earphone housing 210. The speaker module 220 further comprises a speaker housing 222 and a speaker unit 224. The speaker housing 222 constitutes a resonant chamber S20 and the speaker unit 224 is disposed inside the resonant chamber S20. The speaker unit 224 comprises a speaker vibration system and a magneto-electric circuit, for example. The speaker vibration system can be a vibration film on an electric coil. Obviously, the speaker unit 224 is not limited to the aforesaid structure. In fact, any types of speaker units 224 can be used in the present embodiment.

It should be noted that the speaker housing 222 in the present embodiment has only one sound output opening 222a. In other words, the sound produced by the speaker unit 224 will reverberate within the resonant chamber S20 before transmitting to the outside through the sound output opening 222a. The speaker module 220 in the present embodiment incorporates a design after considering various factors that may affect the sound quality and acoustic transmission. Hence, the speaker module 220 disposed within the earphone housing 210 can produce sound of very high quality. In other words, the external appearance of the earphone housing 210 will have little effect on the actual sound quality produced by the earphone 200. Consequently, the earphone housing 210 can have a multitude of designs to meet the demand in the market.

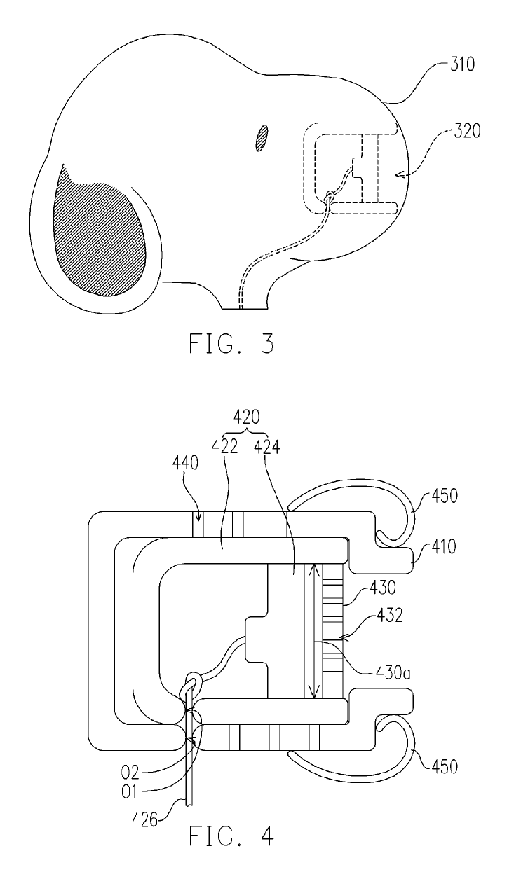

FIG. 3 is a schematic cross-sectional view of an earphone according to a second embodiment of the present invention. As shown in FIG. 3, the earphone 300 in the present embodiment is similar to the earphone 200 in the first embodiment. One major difference is that the earphone 300 of the present embodiment has an earphone housing 310 shaped into a cartoon pattern. In the present embodiment, because the speaker module 320 is capable of producing high-quality sound, the earphone housing 320 can be designed to have various shapes according to commercial considerations and then the speaker module 320 is set up within the earphone housing 310. In other words, there is no need to re-tune or change the original modular design due to the incorporation of a new earphone housing 310. Hence, a new earphone design can be implemented rapidly without incurring additional production cost so that the earphones is more competitive and can obtain a larger share of the earphone market.

Comparing with the conventional technique of selectively laying down a plurality of sound openings on the earphone housing to improve the sound quality and increase the variability of the earphone housing design, the present embodiment can easily provide a multitude of earphone housing design. Furthermore, the earphone can easily produce the stable and unchanging sound from a tuned speaker module. In other words, after designing the speaker module of the earphone, the same speaker module can be applied to all kinds of earphone housing without having to adjust the size and location of the sound openings in each of them as in the conventional technique.

FIG. 4 is a schematic cross-sectional view of an earphone according to a third embodiment of the present invention. As shown in FIG. 4, the earphone 400 in the present embodiment is similar to the earphone 200 in the first embodiment. The major difference is that the earphone 400 includes a few more additional elements. For example, the speaker module 420 of the earphone 400 further includes an electric wire 426 electrically connected a speaker unit 424. The electric wire 426 is used for driving the speaker unit 424 to emit sound. In addition, the speaker housing 422 and the earphone housing 410 both have a wire output opening O1 and O2. The electric wire 426 passes through the wire output opening O1 and the wire output opening O2 and emerges from the earphone housing 410. It should be noted that a portion of the wire body of the electric wire 426 resides between the wire output opening O1 of the speaker housing 422 and the wire output opening O2 of the earphone housing 410. Hence, the sound produced by the speaker module 420 can hardly be transmitted to outside via the output wire opening O1 of the speaker housing 422. Obviously, if the speaker unit 424 deploys a wireless signal reception system, there is no need to use the electric wire 426 or provide the wire output opening O1 and the wire output opening O2.

In addition, the speaker module 420 of the earphone 400 in the present embodiment may further include a cap body 430. The cap body 430 has a plurality of first sound openings 432 that covers the sound output opening 430a. The earphone 400 may includes a plurality of decorative holes 440 disposed on the earphone housing 410. The aforesaid decorative holes 440 increase the variety of designs available for the earphone 400. To add to the comfort of the earphone user, the earphone 400 may further include an ear pad 450 disposed on the earphone housing 410. The ear pad 450 is fabricated using rubber or other suitable material, for example. Obviously, the earphone housing 410 of the present embodiment can have various other design styles.

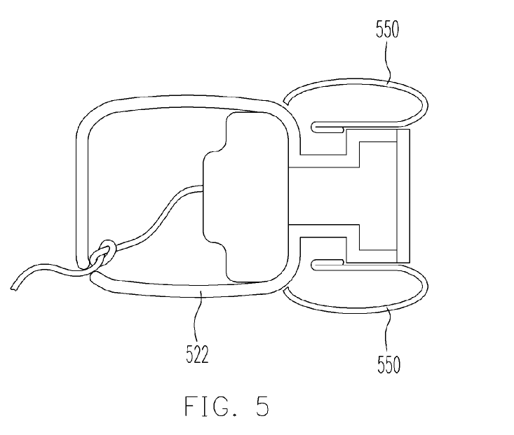

FIG. 5 is a schematic cross-sectional view of an earphone according to a fourth embodiment of the present invention. As shown in FIG. 5, the earphone 500 in the present embodiment is similar to the speaker module 420 in the third embodiment. In other words, the earphone 500 is the speaker module. In addition, the main difference between the earphone 500 and the speaker module 420 is that the external form of the ear pad 550 of the earphone 500 has a design that matches the speaker housing 522 and prevents the ear pad 550 from dropping off.

It should be noted that the earphone in the present invention could be worn in a number of ways. For example, the earphone can be an ear plug type of earphone, an ear hanger type of earphone, a blue-tooth type of earphone or an earmuff type of earphone. In other words, the earphone provided by the present invention can be applied to the earphones of whatever type of wearing mode.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A speaker module for an earphone, comprising:
a speaker housing constituting a resonant chamber, wherein the speaker housing has only one sound output opening, and
a speaker unit disposed inside the resonant chamber.

2. The speaker module of claim 1, wherein the module further includes an electric wire and the speaker housing has a wire output opening such that the electric wire is electrically connected to the speaker unit and passes through the wire outlet opening to emerge outside the speaker housing.

3. The speaker module of claim 1, wherein the module further includes a cap body having a plurality of first sound openings that covers the sound output opening.

4. The speaker module of claim 1, wherein the module further includes an ear pad disposed on the speaker housing.

5. An earphone, comprising:
an earphone housing; and
a speaker module disposed inside the earphone housing, having:
a speaker housing constituting a resonant chamber, wherein the speaker housing has only one sound output opening, and
a speaker unit disposed inside the resonant chamber.

6. The earphone of claim 5, wherein the speaker module further includes an electric wire and the speaker housing and the earphone housing individually have a wire output opening such that the electric wire is electrically connected to the speaker unit and passes through the wire output openings to emerge outside the earphone housing.

7. The earphone of claim 5, wherein the speaker module further includes a cap body having a plurality of first sound openings that covers the sound output opening.

8. The earphone of claim 5, wherein the earphone further includes an ear pad disposed on the earphone housing.

9. The earphone of claim 5, wherein the earphone further includes a plurality of decoration holes disposed on the earphone housing.
